(19) United States
(12) Patent Application Publication
(10) Pub. No.: US 2024/0416288 A1
(43) Pub. Date: Dec. 19, 2024

(54) Porous PTFE Article with Hydrophilic Coating

(71) Applicant: Donaldson Company, Inc., Bloomington, MN (US)

(72) Inventors: Joe A. Jaye, Crystal, MN (US); Matthew P. Goertz, Bloomington, MN (US); Catherine M. Kasse, Eagan, MN (US); Davis B. Moravec, Burnsville, MN (US); Bradly G. Hauser, Minneapolis, MN (US); Madeline C. Peterson, Minneapolis, MN (US); David A. Olson, Minneapolis, MN (US); Cecilia C. Hall, Minneapolis, MN (US); S. Kyle Sontag, Plymouth, MN (US); Elizabeth A. Jackson, Minneapolis, MN (US)

(21) Appl. No.: 18/742,942

(22) Filed: Jun. 13, 2024

Related U.S. Application Data
(60) Provisional application No. 63/521,073, filed on Jun. 14, 2023.
(60) Provisional application No. 63/521,076, filed on Jun. 14, 2023.
(60) Provisional application No. 63/521,065, filed on Jun. 14, 2023.

(51) Int. Cl. B01D 67/00; B01D 69/02; B01D 71/36

(52) U.S. Cl. CPC B01D 67/0088; B01D 69/02; B01D 71/36; B01D 2323/02; B01D 2325/02834; B01D 2325/04; B01D 2325/36

(57) ABSTRACT

Porous ePTFE articles coated with a hydrophilic coating are provided. The coating may be modified by covalent modifications to the PVOH coating. Covalent modifications may include small molecule grafting, polymer grafting to or from the PVOH backbone, modifying the PVAc precursor of the PVOH, crosslinking of the polymer via thermal or photochemistry, crosslinking of the polymer with a multifunctional crosslinking agent, and the like, and combinations thereof.

### CROSS REFERENCE TO RELATED APPLICATIONS

This application claims the benefit of U.S. 63/521,073, filed 14 Jun. 2023; U.S. 63/521,076, filed 14 Jun. 2023; and U.S. 63/521,065, filed 14 Jun. 2023, the disclosures of which are incorporated by reference herein in their entireties.

### FIELD

The present disclosure relates to porous articles made of PTFE and including a hydrophilic coating. The present disclosure further relates to porous articles made of ePTFE and including a hydrophilic coating containing PVOH and/or chemically modified PVOH.

### SUMMARY

Porous ePTFE articles coated with a hydrophilic coating are provided.

According to an embodiment, the coating is modified by utilizing compositions and/or methods that allow the modification of the properties of the film as desired. For example, the hydrophilic PVOH coating may be applied in a way that allows the thickness, morphology, wetting properties, polymer crystallinity, etc., to be controlled and modified.

According to an embodiment, the coating includes an interpenetrating polymer network of PVOH and a second polymer. The second polymer may include one or more of polyacrylic acid, poly(2-ethyl-2-oxazoline), poly(hydroxyethyl methacrylate), poly(hydroxyl propyl methacrylate), or polyethylene glycols.

According to an embodiment, the coating includes a first layer of poly(vinyl alcohol) and a second layer on the first layer and including one or more of polyacrylic acid, poly (2-ethyl-2-oxazoline), poly(hydroxyethyl methacrylate), poly(hydroxyl propyl methacrylate), or polyethylene glycol.

According to an embodiment, the coating includes a first layer of poly(vinyl alcohol) and a second layer on the first layer and including a water-insoluble polymer.

According to an embodiment, the coating is modified by modifying the PVOH in the coating composition or in the coating (after the coating composition has been applied onto the porous substrate). Such modifications may include covalent modifications to the PVOH coating. Covalent modifications may include small molecule grafting, polymer grafting to or from the PVOH backbone, modifying the PVAc precursor of the PVOH, crosslinking of the polymer via thermal or photochemistry, crosslinking of the polymer with a multifunctional crosslinking agent, and the like, and combinations thereof.

According to an embodiment, the coating includes an interpenetrating polymer network of PVOH and a second polymer. The second polymer may include one or more of polyacrylic acid, poly (2-ethyl-2-oxazoline), poly(hydroxyethyl methacrylate), poly(hydroxyl propyl methacrylate), or polyethylene glycols.

According to an embodiment, the coating includes a first layer of poly(vinyl alcohol) and a second layer on the first layer and including one or more of polyacrylic acid, poly (2-ethyl-2-oxazoline), poly(hydroxyethyl methacrylate), poly(hydroxyl propyl methacrylate), or polyethylene glycol.

According to an embodiment, the coating includes a first layer of poly(vinyl alcohol) and a second layer on the first layer and including a water-insoluble polymer.

### BRIEF DESCRIPTION OF DRAWINGS

FIG. 1 is a schematic depiction of a porous article according to embodiments of the present disclosure.

FIG. 2 is a schematic depiction of a filter containing the porous article of FIG. 1.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. The term “polymer” further includes different polymer architectures, such as linear, branched, bottle brush, dendrimers, etc. Furthermore, unless otherwise specifically limited, the term “polymer” shall include all possible geometrical configurations of the material. These configurations include, but are not limited to, isotactic, syndiotactic, and atactic symmetries.

The terms “formed from,” “polymerized from,” and “grafter from” are open ended and may include other components that may not be expressly described relative to the subject that is formed from or polymerized from the stated components. For example, a polymer formed from or polymerized from one or more monomers may include capping groups or other groups not expressly mentioned.

The term “grafter to” refers to a technique where an already formed polymer is covalently attach to a surface or another polymer, as the case may be.

The term “grafter from” refers to a polymerization technique where a polymer chain grown from a surface or another polymer. Grafting from may involve polymerization from an initiator-functionalized surface. Polymers that are grafted from may be grown one monomer at a time.

The term “hydrophilic” as used here can be understood to have the meaning of “a tendency to mix with, dissolve in, or be wetted by water”, and can be understood to have the inverse meaning of “hydrophobic.” Hydrophobic materials are defined as materials with a water contact angle greater than 90°, while hydrophilic materials are defined as materials with a water contact angle less than 90°. Hydrophilicity can be measured by measuring the water contact angle of a material using ASTM D7334-08R22 test method, or by using an automated contact angle tester and ASTM D5725-99 test method.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure relates to the application of hydrophilic coatings onto porous ePTFE articles. Expanded polytetrafluoroethylene (“ePTFE”) is manufactured using a stretching process. ePTFE is porous and may be used to provide porous membranes. Such porous membranes may be useful as filter media, separator films, semi-permeable barriers, etc. ePTFE may form one or more layers of filter media and may be used in filters for air and solvent purification. However, the strong hydrophobicity of ePTFE may decrease its performance when used in contact with water.

Polytetrafluoroethylene (PTFE) is a valuable material with a broad array of uses across a variety of industries. Hydrophobicity and low surface energy of PTFE present challenges in certain applications, especially when wetting of a surface area is needed. Attempts to raise the hydrophilicity of PTFE materials have included grafting acrylic acid, 4-vinylpyridine, and N-vinylpyrrolidone on PTFE via ionizing radiation-induced or catalyzed polymerization reactions. With this method, uniform hydrophilicity is not achieved because graft copolymerization acts on the surface layer of the PTFE and does not reach the interior of the material. To overcome this issue and extend graft polymerization into the interior of porous PTFE, impregnation with a surface-active agent and etching are utilized. However, non-uniform hydrophilicity persists with smaller pore sizes.

The hydrophilicity of PTFE materials is especially desirable for providing porous membranes for applications where wetting of the membrane is desired. Such applications include membrane filters, ultrafiltration membranes, dialysis membranes, reverse osmosis membranes, etc. Superior mechanical properties and good permeability are desirable characteristics for hydrophilic polymer membranes used for similar applications.

The creation of a hydrophilic surface on ePTFE membranes presents a challenge. Modifying the surface of ePTFE to make it amenable to wetting for use in filtration applications in the food, beverage, and pharmaceutical industries, is highly desirable.

PTFE is known to be hydrophobic and to have a low surface energy due to the high density of fluorine on the surface which result in a low surface energy. The low surface energy makes PTFE challenging to modify by applying a coating as most materials will not adhere to the surface of PTFE. In some cases, it is desirable to provide PTFE articles with a hydrophilic surface. In some cases, it is desirable to provide PTFE articles with a water wettable surface. Such hydrophilic and wettable surfaces may be achieved by applying a hydrophilic coating containing poly(vinyl alcohol) (“PVOH”) onto the surface of PTFE. Such hydrophilic and wettable surfaces may further be achieved by applying a hydrophilic coating containing PVOH onto porous ePTFE.

The present disclosure relates to improvements to hydrophilic-coated ePTFE articles, including hydrophilic-coated ePTFE membranes, films, and filter media. According to an embodiment, the ePTFE article includes a porous ePTFE substrate coated with a coating composition containing PVOH.

Generally, PVOH may be applied onto the porous substrate (e.g., porous ePTFE film or membrane) by applying PVOH in an aqueous solution, creating a thin film of PVOH on the porous substrate. The solution may optionally be removed, although removal is not necessary for the formation of the PVOH coatings on the PTFE. The PVOH may be subsequently crosslinked. For example, the porous substrate may be coated by immersing, dip coating, spraying, printing, or brushing a coating composition onto the porous substrate. The porous substrate may be prewetted prior to coating. The coated substrate may be rinsed after coating. The coating composition may be dried and/or cured onto the porous substrate. In one exemplary embodiment, the porous substrate is prewetted using water or an aqueous solvent composition or a water miscible solvent such as acetone, ethanol, or isopropanol. The solvent may be displaced with water. The substrate (still wet with water) may be placed in contact with an aqueous bath containing the coating composition.

The concentration of PVOH in the aqueous solution may be 0.1 wt-% or greater, 0.2 wt-% or greater, 0.5 wt-% or greater, 1 wt-% or greater, 2 wt-% or greater, 3 wt-% or greater, 4 wt-% or greater, or 5 wt-% or greater. The concentration of PVOH in the aqueous solution may be 20 wt-% or less, 10 wt-% or less, 5 wt-% or less, 4 wt-% or less, 3 wt-% or less, or 2 wt-% or less. The hydrolyzation rate of the PVOH may be 88% or greater, 90% or greater, 95% or greater, 98% or greater, or 99% or greater. The molecular weight of the PVOH may be 50 kDa or greater, 75 kDa or greater, or 80 kDa or greater. The molecular weight of the PVOH may be 120 kDa or less, 100 kDa or less, or 90 kDa or less. In some embodiments, the PVOH is 99% or more hydrolyzed, has a molecular weight of 80 kDa to 90 kDa, and is included in water at a concentration of 1.5 wt-% to 2.5 wt-%.

For example, the substrate may be placed in an aqueous bath containing 1-2 wt-% of fully (99%) hydrolyzed poly(vinyl alcohol) for at least 2 minutes. The aqueous bath may be at room temperature or above room temperature. Room temperature is understood to mean a temperature of about 20° C. to 26° C. The substrate may then be rinsed. A cross-linking composition containing a crosslinking agent suitable for crosslinking the coating composition (e.g., PVOH) may be applied onto the substrate. In some embodiments, the substrate may be rinsed with water and immersed in an aqueous solution of glutaraldehyde and H₂SO₄ at an elevated temperature. For example, the substrate may be immersed in an aqueous solution of 2 mM to 8 mM (e.g., about 5 mM) glutaraldehyde and 0.1 M to 0.5 M (e.g., about 0.25 M) H₂SO₄ at a temperature of 40° C. to 80° C. (e.g., about 60° C.) for 1 minute to 5 minutes (e.g., about 2 minutes).

The coating composition may penetrate the porous substrate at least part of the way such that internal surfaces, such as surfaces of individual fibers or surfaces of pores become coated. In some embodiments, the coating composition penetrates the porous substrate all the way such that both major surfaces as well as internal surfaces are coated. According to an embodiment, the coatings according to the present disclosure may be characterized as being conformal. The term “conformal” as used here refers to a coating that follows the surface contours of the base layer so that the coating is present on the whole surface irrespective of surface roughness or defects.

According to an embodiment, the coating may be modified by modifying the PVOH in the coating composition or in the coating (after the coating composition has been applied onto the porous substrate). Such modifications may be applied to alter the polymer surface and its mechanical properties. The modifications may include covalent modifications to the PVOH coating. Covalent modifications may include small molecule grafting, polymer grafting to or from the PVOH backbone, crosslinking of the polymer via thermal annealing or photochemistry, and the like, and combinations thereof. This polymer will have a different chemical composition than unmodified PVOH coatings.

In some embodiments, the PVOH coating is modified by grafting biomolecules onto the PVOH coating. This may improve the biocompatibility of the resulting coated porous article. Examples of such biomolecules include amino acids, peptides, proteins, saccharides, polysaccharides, oligosaccharides, and the like. In some embodiments, the PVOH coating is modified by grafting starch, chitosan, cellulose, gelatin, heparin, synthetic polypeptides, or a combination of two or more thereof onto the PVOH. The coupling may be done using known coupling chemistries. In some embodiments, PVOH is coupled via glutaraldehyde, dicyclohexylcarbodiimide, carbonyldiimidazole, or other carbodiimide chemistry, disuccinimidyl carbonate, epichlorohydrin, or other suitable coupling agent. The grafting may involve contacting the PVOH with the biomolecule of interest and a coupling agent. The biomolecule to be coupled with the PVOH may be included at a rate of 0.1 wt-% to 100 wt-% based on the weight of the PVOH. In addition, a modified PVOH containing the appropriate functional group can be further reacted with a biomolecule of interest containing maleimide derivatives, iodoacetamide derivatives, alkyne-azide chemistry derivatives, thiol-ene chemistry derivatives, thiol-yne chemistry derivatives, isocyanate derivatives, or the like, including other reactive group derivatives known as click chemistry or covalent bioconjugation techniques, to increase biocompatibility. A method of forming the coated article may include covalently coupling the biological molecule to the poly(vinyl alcohol), where the biological molecule has a first reactive handle, and the poly(vinyl alcohol) has a second reactive handle, and where the first reactive handle and the second reactive handle are cooperative and react in a bioconjugation reaction.

In some embodiments, the PVOH coating is modified by grafting oligomers and/or polymers onto the PVOH coating. The PVOH coating is modified by attaching a second fully formed polymer onto the PVOH. The second polymer may be a hydrophilic polymer having a molecular weight of 500 Da to 100 kDa. The second may be grafted to the PVOH backbone using known grafting chemistries. Exemplary grafting technique include coupling via glutaraldehyde, dicyclohexylcarbodiimide or other carbodiimide chemistry, carbonyldiimidazole, disuccinimidyl carbonate, epichlorohydrin, or other suitable coupling agent. The grafting may involve contacting the PVOH with the second polymer, and the coupling agent. In addition, a modified PVOH containing a functional group can be further reacted with a modified hydrophilic polymer of interest containing one or more reactive handles, such as a maleimide derivatives, iodoacetamide derivatives, alkyne-azide chemistry derivatives, thiol-ene chemistry derivatives, thiol-yne chemistry derivatives, isocyanate derivatives, N-hydroxysuccinimide ester (NHS), or the like, including other reactive group derivatives known as click chemistry or conjugation techniques. Example polymers to be grafted include polyethylene glycol (PEG), linear polyethylene imine (PEI), polyallyl alcohol (PAIA), polyacrylic acid (PAA), polyacrylic acid sodium salt (PAANa), and poly (2-hydroxyethyl methacrylate) (PHEMA).

In some embodiments, the PVOH coating is modified by grafting polymers and/or oligomers through grafting-from technology such as surface initiated polymerization onto the PVOH coating. Grafting-from polymerization may be accomplished using suitable techniques such as addition polymerization or condensation polymerization. Examples of addition polymerization techniques include free radical polymerization, such as atom transfer radical polymerization (ATRP) and reversible addition fragmentation chain transfer (RAFT) polymerization; anionic polymerization; and cationic polymerization. In some embodiments, where the polymer is grafted from the support substrate or the polymer already on the substrate, an initiator is first coupled to the support substrate or the polymer already on the substrate (e.g., through an OH group on the support substrate or polymer). Hydrophilic polymers (e.g., PEG, polyglycidyl ether, polylactides, polycarbonates, having 100 or fewer, 80 or fewer, 60 or fewer, 40 or fewer, or 20 or fewer repeating units, and 4 or more, 6 or more, 10 or more, 15 or more, or 20 or more repeating units) can be grafted from PVOH through use of ring opening polymerization of ethylene oxides, other cyclic ether, cyclic esters, or cyclic carbonate derivatives, through acid or base catalyzed ring-opening polymerizations. Hydrophilic acrylate derivatives (e.g., polyacrylic acid (PAA), polyacrylic acid sodium salt (PAANa), poly (2-hydroxyethyl methacrylate) (PHEMA), having repeat units with N=1-100) can be grafted from the PVOH polymer through PVOH modification with an atom transfer radical polymerization (ATRP) initiator (e.g., α-haloester derivatives, or other common ATRP initiators). Hydrophilic acrylate derivatives can also be grafted from the PVOH polymer through modification of the PVOH with a reversible addition-fragmentation chain-transfer polymerization (RAFT) initiator (dithiocarbonyl derivative, thiocarbonylthio derivative, or other common chain transfer agents (CTAs)).

In some embodiments, the PVOH is crosslinked through dialdehydes catalyzed by photoacids. A dialdehyde, (e.g., glutaraldehyde, terephthalaldehyde, phthalaldehyde, or glyoxal) can be used as a cross-linker at 0.1-20 wt-% in a solution containing PVOH, dialdehyde, solvent (water, ethanol, isopropanol, DMF, DMSO, or the like), and a photoacid catalyst (triphenylsulfonium triflate or other common photoacids). The composition may be applied onto the porous substrate and illuminated with UV light. Upon illumination with UV light, acid-catalyzed crosslinking is initiated. The specific wavelength of the UV light may be selected based on the photoacid catalyst. For example, wavelength of 233 nm may be used for triphenylsulfonium triflate, or other wavelengths for various photoacids.

In some embodiments, the PVOH coating is modified by incorporating other, more easily cross-linkable groups in the PVOH. The PVOH polymer may be modified prior to deposition onto the porous substrate to include easily cross-linkable functional groups. The cross-linkable functional groups may be more easily crosslinked than PVOH by itself. For example, PVOH may be reacted with a 1-20 wt-% solution of allyl glycidyl ether, propargyl glycidyl ether, acryloyl chloride derivatives, or other activated acrylic ester derivatives in a solvent of choice (e.g., water, ethanol, isopropanol, DMF, DMSO), be utilized to place allyl, propargyl, diazirine, or acrylate functional groups on the polymer. These functional groups may then be cross-linked via UV light, thermal annealing, or chemical additives such as dithiols, diazides, diamines, or diols. The resulting porous article may include a porous ePTFE substrate and a coating disposed on the porous substrate, the coating including poly(vinyl alcohol) including crosslinked allyl groups, propargyl groups, diazirine groups, acrylate functional groups, or a combination of two or more thereof.

PVOH is typically prepared industrially by hydrolysis of polyvinylacetate (“PVAc”). In some embodiments, the PVOH coating is modified by incorporating other, more easily cross-linkable groups in the PVOH by modifying the PVAc precursor prior to hydrolyzing the PVAc into PVOH. Monomers containing easily cross-linkable groups can be added to the polymerization solution of PVAc to produce a copolymer of PVAc and a comonomer containing functional handles prior to hydrolysis. The content of PVAc in the copolymer may be from 90 to 99 mol-%, and the content of the comonomer may be from 1 mol-% to 10 mol-%. Functional groups, such as cyclic ethers or allyl groups may be incorporated via copolymerization with glycidyl methacrylate or allyl methacrylate, respectively. Other functional groups may be incorporated through copolymerization with acrylate derivatives, or other activated vinyl monomers, which contain aldehydes, alkynes, alkenes, alkyl halides, diazirines, cyclic ethers, cyclic esters or other reactive functionalities. The resulting porous article may include a porous ePTFE substrate and a coating disposed on the porous substrate, the coating including poly(vinyl alcohol) including crosslinked allyl groups, propargyl groups, diazirine groups, acrylate functional groups, or a combination of two or more thereof.

In some embodiments, the PVOH coating is modified by crosslinking the PVOH with a crosslinking agent having greater than two reactive groups per crosslinking agent. In place of the difunctional crosslinking agents typically used, a trifunctional (or higher order) crosslinking agent may be utilized to crosslink the PVOH to increase the crosslinking density of the resulting coating, to increase the thermal stability, and/or to increase oxidation resistance. For example, a trifunctional aldehyde such as 2,4,6-trihydroxybenzene-1,3,5-tricarbaldehyde can be used in place of glutaraldehyde in acid-catalyzed crosslinking of the polymer. Alternatively, a triglycidyl ether crosslinking agent such as trimethylolethane triglycidyl ether or trimethylolpropane triglycidyl ether can be used as trifunctional crosslinking agent through acid or base promoted ring opening. Other examples of crosslinking agents include small molecules or oligomeric molecules containing more than two reactive functional groups such as aldehydes, cyclic ethers, cyclic esters, or alkyl halides. Alternatively, the PVOH may be modified to include cross-linkable functional groups (e.g., allyl, propargyl, or acrylate functional groups) to form a modified PVOH, and the modified PVOH may be crosslinked with a trithiol, tetrathiol, or elemental sulfur via photoinitiated chemistry or thermal annealing. Modified PVOH containing acrylate functional groups can be crosslinked through thermal annealing of small molecules or oligomers containing more than two amine groups, such as tris(2-aminoethyl)amine, diethylene triamine, linear polyethylene imine, or branched polyethylene imine.

According to an embodiment, the coating may be modified by utilizing compositions and/or methods that allow the modification of the properties of the film as desired. For example, the hydrophilic PVOH coating may be applied in a way that allows the thickness, morphology, wetting properties, polymer crystallinity, etc., to be controlled and modified.

According to an embodiment, the coating is prepared by depositing the PVOH as a coating composition including large macromolecular aggregates of PVOH. Typical PVOH coating compositions include PVOH having a molecular weight of about 80 kDa to 90 kDa. The macromolecular aggregates may include multiple individual PVOH chains and have a molecular weight of 250 kDa or greater or 300 kDa or greater. The coating containing macromolecular aggregates of PVOH may exhibit enhanced wettability. Deposition of the macromolecular aggregates may be accomplished in at least two ways. First, exposure of an ePTFE substrate to a solution of PVOH at a concentration above the critical entanglement concentration for PVOH may produce a coating with co-adsorption of individual chains and entangled macromolecular aggregates. The critical entanglement concentration for PVOH in water is estimated to be about 0.2 M as measured by the number of vinyl alcohol induvial repeat units. To produce macromolecular aggregates in the coating, the molecular weight distribution of the PVOH polymer chains may be between 10 kDa and 300 kDa. A second method to accomplish macromolecular aggregates in the coating is exposure of an ePTFE membrane to a PVOH solution containing individual polymer chains with molecular weights of 300 kDa or greater. These extremely large molecular weight chains may deposit as particulates instead of as morphologically smooth films.

According to an embodiment, the coating is prepared by contacting the ePTFE porous substrate with the coating composition containing PVOH in a temperature range of 40° C. to 55° C. The coating composition may include PVOH and water. The concentration of PVOH in the coating composition may be about 1 wt-% to 10 wt-%. The coating may be applied by any suitable method, such as dip coating. The coating composition may be heated to the desired temperature range of 40° C. to 55° C. The heated coating composition may be applied to the substrate, for example, by immersing the substrate in the heated coating composition. The immersion time may be 1 min or longer, 1.5 min or longer, 2 min or longer, 5 min or longer, or 10 min or longer. The immersion time may be 1 hour or less, 30 min or less, 20 min or less, 15 min or less, 10 min or less, 5 min or less, 3 min or less, or 2 min or less. The immersion time may be from 1 min to 1 hour, or from 1 min to 5 min. The coating composition may also contain adsorbent structure modifiers such as salts and surfactants, as further discussed below.

According to an embodiment, the coating is prepared by including one or more of chaotropic, kosmotropic, or zwitterionic additives in the coating composition. Such chaotropic, kosmotropic, and zwitterionic additives may be salts or other suitable compounds. The inclusion of one or more such additives allows improved control of the PVOH film structure. Examples of kosmotropes include ammonium sulfate, tert-butanol, and trehalose. Examples of chaotropes include sodium thiocyanate, guanidinium chloride, and n-butanol. Examples of zwitterions include phosphatidylcholine. The coating composition may include one or more additives at a concentration of 0.01 mol/L or greater, and up to 2 mol/L.

According to an embodiment, the coating is prepared by applying the PVOH in two or more coating steps, where at least one of the process parameters is changed from the first step to the second or subsequent step. Process parameters that may be varied between the steps include temperature, additive (e.g., chaotropic, kosmotropic, or zwitterionic additives), molecular weight distribution of the PVOH, degree of hydrolysis of the PVOH, and the use of a surfactant in the coating composition. One or more of the process parameters may be changed at the same time. In one exemplary embodiment, the PVOH coating is applied in two steps, where in a first step, a coating composition containing PVOH with a high molecular weight distribution of 90 kDa to 185 kDa is deposited at 80° C., followed by a second deposition of PVOH with a narrower molecular weight distribution of 80 kDa to 90 kDa at 20° C. In another exemplary embodiment, the PVOH coating is applied in two steps, where in both steps the PVOH has a molecular weight distribution of 80 kDa to 90 kDa at 20° C. but the coating composition in the first step contains 2 M NaCl and the coating composition in the second steps contains 0.1 M NaSCN (sodium thiocyanate).

According to an embodiment, the coating is prepared by reversibly co-adsorbing a surfactant with the PVOH to produce PVOH films with enhanced wetting and stability. Examples of suitable surfactants that may be used include an anionic surfactant, such as sodium dodecyl sulfate (i.e., sodium lauryl sulfate); a non-ionic surfactant, such as sorbitan monooleate such as SPAN 80®, polyethylene glycol sorbitan monolaurate such as TWEEN 20®, or polyoxyethylene-polyoxypropylene block co-polymer such as PLURONIC® F127; or a combination of two or more thereof. The surfactant may be included in the coating composition at a concentration of 0.5 wt-% or greater, 1 wt-% or greater, 1.5 wt-% or greater, or 2 wt-% or greater. The surfactant may be included in the coating composition at a concentration of 5 wt-% or less, 4 wt-% or less, 3 wt-% or less, or 2 wt-% or less. Multiple surfactants may be combined in the coating composition.

According to an embodiment, the coating is prepared by deposition two or more different grades of PVOH onto the substrate. The different grades of PVOH may include PVOH of varying molecular weight distribution, varying degree of hydrolysis, and varying concentrations. In an exemplary embodiment, the coating composition (applied in a single step) includes a first concentration of PVOH with 85% hydrolysis and molecular weight of 80 kDa to 90 kDa, and a second concentration of PVOH with 99% (or greater) hydrolysis and molecular weight of 80 kDa to 140 kDa. The first concentration may be lower than the second concentration. For example, the first concentration may be about 0.1 wt-% and the second concentration may be about 5 wt-%.

According to an embodiment, the coating may be modified by including a second, different polymer in the PVOH coating. For example, coating composition may be prepared such that an interpenetrating polymer network (“IPN”) is formed. An IPN is a polymer network including two or more polymers which are at least partially interlaced on a polymer scale but not covalently bonded to each other. The polymers of an IPN typically cannot be separated from one another unless chemical bonds are broken. Alternatively, another polymer is added as a second coating on the PVOH coating. According to an embodiment, one or more additional polymers, oligomers, or small molecules are either mixed into or layered on top of the PVOH layer. The additional polymers, oligomers, or small molecules may adhere to or be entangled with the PVOH but are not covalently bonded to the PVOH. The second polymer may be added, for example, by using a saturation coating technique such as dip coating or spray coating to saturate a PVOH coated ePTFE substrate with a second polymer carried by a fluid. This may be followed by removal of the carrier fluid through drying. Application of the second polymer may form a second conformal coating over the first PVOH coating.

According to an embodiment, a solution of PVOH and another polymer is applied onto an ePTFE substrate. The second polymer may be one that does not have inherent affinity or binding capacity to the ePTFE. The PVOH adsorbs onto the ePTFE and entraps the second polymer through non-covalent entanglements, forming an interpenetrating polymer network. The entanglement may involve hydrogen bonding or be mechanical in nature. According to an embodiment, the entanglement is sufficient to permanently entrap the second polymer into the structure of the PVOH coating. The second polymer may be selected to provide desired properties, such as add hydrophilicity, mechanical strength, biocompatibility, or charge into the coating. The coating may optionally be applied in a two step process in which the PVOH is first deposited and then exposed to a high concentration of the second polymer. The second polymer may be chosen and sufficient time for rearrangement may be allowed such that diffusion occurs and the second polymer will intercalate into the adsorbed PVOH film.

An IPN can also be made by polymerizing and/or crosslinking a second network through a first network. For example, one of the two polymer components (e.g., a second polymer) of the IPN may start out as a monomer that is crosslinked within the network of the other polymer (e.g., PVOH).

Examples of a second polymer that may be used to form an IPN with PVOH include polyacrylic acid, poly (2-ethyl-2-oxazoline), poly(hydroxyethyl methacrylate), poly(hydroxyl propyl methacrylate), poly (4-vinylpyridine), poly(vinyl pyrrolidone), and polyethylene glycols. The PVOH used in the coating composition may have a higher molecular weight than would typically be used in preparing PVOH coatings. That is, the PVOH may have a molecular weight that is greater than 90 kDa. The coating composition may include PVOH and one or more of polyacrylic acid, poly (2-ethyl-2-oxazoline), poly(hydroxyethyl methacrylate), poly(hydroxyl propyl methacrylate), poly (4-vinylpyridinc), poly(vinyl pyrrolidone), or polyethylene glycols. The resulting coating may include an interpenetrating polymer network of PVOH and one or more of polyacrylic acid, poly (2-ethyl-2-oxazoline), poly(hydroxyethyl methacrylate), poly(hydroxyl propyl methacrylate), poly (4-vinylpyridine), poly(vinyl pyrrolidone), or polyethylene glycols.

According to an embodiment, the PVOH coating is modified by applying a second polymer onto the PVOH coating, where the second polymer is capable of strongly adhering to the PVOH. The coating may be applied in two steps, where the first step involves contacting the porous ePTFE substrate with a first coating composition including PVOH, and then contacting the substrate with a second coating composition including the second polymer. The second polymer may include, for example, polyacrylic acid, poly (2-ethyl-2-oxazoline), poly(hydroxyethyl methacrylate), poly(hydroxyl propyl methacrylate), or polyethylene glycols. The resulting coating may include a first layer of poly(vinyl alcohol) and a second layer on the first layer and including one or more of polyacrylic acid, poly (2-ethyl-2-oxazoline), poly(hydroxyethyl methacrylate), poly(hydroxyl propyl methacrylate), or polyethylene glycol.

In some embodiments, a second polymer is applied as a second coating onto the PVOH coating. The deposition of the PVOH coating may be followed by at least a second coating of a water-insoluble polymer through removal of a carrier liquid that contains the second polymer. Examples of suitable polymers include poly (2-hydroxylethylmethacrylate) and poly(hydroxylpropyl methacrylate). The water-insoluble polymer may also be achieved by application of a polymer that is water soluble prior to application and crosslinking and may become water insoluble upon crosslinking. Examples of water-soluble polymers that may become water insoluble after crosslinking are poly(lactic-co-glycolic acid) and poly(ethyleneimine). In an exemplary embodiment, the PVOH is coated onto an ePTFE substrate, followed removal of the solution to leave a residual PVOH film on the ePTFE. The coated substrate is then contacted with a solution of poly(lactic-co-glycolic acid) in tetrahydrofuran to form the second coating. In another example, the second polymer is poly(ethyleneimine) in methanol with a crosslinking agent of formaldehyde. The methanol is evaporated and the crosslinking occurs at 90° C. for 10 minutes. In another example, poly (2-hydroxyethylmethacrylate) is deposited from isopropanol and the isopropanol is evaporated.

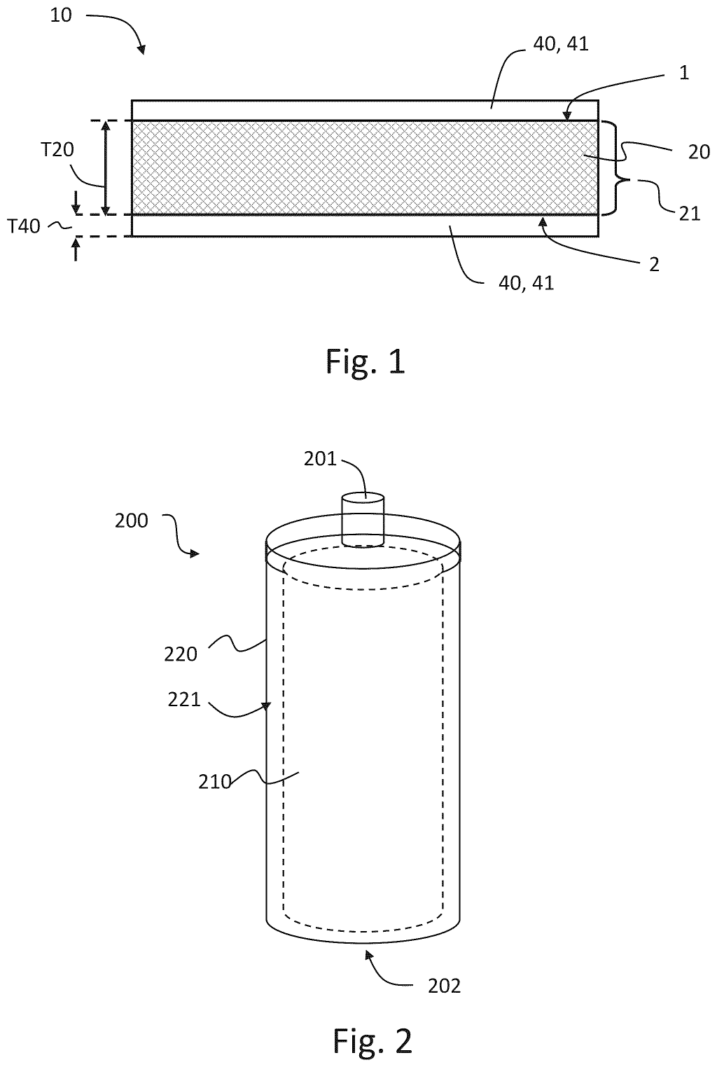

Reference is now made to FIGS. 1 and 2. The present disclosure describes coated porous article 10. The coated porous article 10 may be used as filter media. The present disclosure further describes filters 200 including the coated porous article 10 (e.g., filter media), methods of making the coated porous article 10, and methods of using the coated porous article 10 (e.g., filter media). It should be noted that although the figures show a coated filter media, the methods of the present disclosure may also be used to apply coatings to surfaces of other articles. In particular, the methods of the present disclosure may be useful for applying coatings onto articles including ePTFE that include a porous surface that may benefit from the hydrophilic coating.

The coated porous article 10 of the present disclosure, as schematically shown in FIG. 1, generally includes a porous substrate 20 that is coated with a coating 40 that includes a hydrophobic coating composition 41. The coating may be present on the major surfaces 1, 2 of the porous substrate 20 and also on surfaces of pores. Although the coating 40 is shown as solid layers in FIG. 1, the coating 40 may at least partially coat each fiber and surfaces of pores of the porous substrate 20. That is, the coating 40 may form a conformal coating on the porous substrate 20. The porous substrate may have a thickness T20 and the coating 40 may have a thickness T40.

A filter 200 is shown in FIG. 2. The filter 200 may include a housing 220 with an interior 221, an inlet 201, and outlet 202. A filter media 210 made of or including the coated porous article is disposed within the interior 221 or the housing 220.

The porous substrate may be provided as a thin film or membrane. The porous substrate may have any thickness suitable for its intended purpose. The porous substrate may have a thickness of 0.1 μm or greater, 0.5 μm or greater, 1 μm or greater, 5 μm or greater, 10 μm or greater, or 100 μm or greater. The porous substrate may have a thickness of 5 mm or less, 2 mm or less, 1 mm or less, 500 μm or less, 200 μm or less, 100 μm or less, 50 μm or less, 25 μm or less, 10 μm or less, 5 μm or less, 2 μm or less, or 1 μm or less.

According to an embodiment, the coating forms a very thin layer on the porous substrate. Preferably, the coating is thin enough so as not to clog the pores of the porous substrate. The coating may have a thickness of 250 nm or less, 200 nm or less, 150 nm or less, 100 nm or less, 50 nm or less, 20 nm or less, 10 nm or less, or 5 nm or less. The coating may have a thickness of 0.5 nm or greater.

The coated porous substrate may have an average pore size of 1 mm or less, 100 μm or less, 10 μm or less, 1 μm or less, 0.6 μm or less, 0.5 μm or less, 0.4 μm or less, 0.3 μm or less, 0.2 μm or less, 0.1 μm or less, or 0.01 μm or less. The porous substrate may have an average pore size of 1 nm or greater, 5 nm or greater, 10 nm or greater, 0.1 μm or greater, 1 μm or greater, 10 μm or greater, or 100 μm or greater. The average pore size of the porous substrate may be in a range of 1 nm to 1 mm, 1 nm to 1 μm, 1 nm to 0.5 μm, 0.1 μm to 0.6 μm, 1 μm to 1 mm, or 100 μm to 1 mm. A method for measuring pore size is described in ASTM D6767-21.

The permeability of the porous substrate or coated porous article may be measured by measuring its Frazier permeability as described in ASTM D737-18, using a Frazier Permeability Tester available from Frazier Precision Instrument Co. Inc., Gaithersburg, Maryland. The unit for Frazier permeability is 1 cfm/ft² at 0.5″ water pressure drop, which is equivalent to 0.5 cm³/s/cm² at 125 Pa. In some embodiments, the coated porous article 10 (e.g., filter media) has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability of the coated porous article 10 (e.g., filter media) may be 2 cm³/s/cm² or less, 1.5 cm³/s/cm² or less, 1.0 cm³/s/cm² or less, or 0.8 cm³/s/cm² or less.

The coated porous article exhibits improved wettability as compared to uncoated ePTFE membranes. According to embodiments, the coated porous article includes a coating that renders the article wettable with water. The term “wettable,” as used here, refers to a material that allows a fluid to spread evenly across its surface. In the case of a porous wettable material, the fluid will penetrate into the material and spread throughout the material, including into the pores. Wettability of materials may be measured by ASTM D7334-08R22 test method.

### Embodiments

The following is a list of various embodiments of the present disclosure.

Embodiment 1 is a porous article comprising:
a porous substrate comprising ePTFE; and
a coating disposed on the porous substrate, the coating comprising macromolecular aggregates of poly(vinyl alcohol).

Embodiment 2 is a method of forming a porous article comprising:
a porous substrate comprising ePTFE; and
a coating disposed on the porous substrate, the coating comprising poly(vinyl alcohol), the method comprising:
   preparing a coating composition comprising an aqueous solution of poly(vinyl alcohol);
   heating the coating composition to a temperature of 40° C. to 55° C.; and
   dipping the porous substrate into the heated coating composition.

Embodiment 3 is a method of forming a porous article comprising:
a porous substrate comprising ePTFE; and
a coating disposed on the porous substrate, the coating comprising poly(vinyl alcohol), the method comprising:
   preparing a coating composition comprising an aqueous solution of poly(vinyl alcohol) and one or more additives comprising a chaotropic, kosmotropic, or zwitterionic additive; and
   dipping the porous substrate into the coating composition.

Embodiment 4 is a method of forming a porous article comprising:
a porous substrate comprising ePTFE; and
a coating disposed on the porous substrate, the coating comprising poly(vinyl alcohol), the method comprising:
   preparing a first coating composition and a second coating composition, each of the first and second coating compositions comprising an aqueous solution of poly(vinyl alcohol), wherein one or more of temperature, inclusion of an additive, molecular weight distribution of the poly(vinyl alcohol), degree of hydrolysis of the poly(vinyl alcohol), or a combination thereof, is different between the first coating composition and the second coating composition; and
   dipping the porous substrate into the first coating composition and into the second coating composition.

Embodiment 5 is the method of any one of embodiments 2 to 4, wherein the aqueous solution comprises 0.1 wt-% or greater, 0.2 wt-% or greater, 0.5 wt-% or greater, 1 wt-% or greater, 2 wt-% or greater, 3 wt-% or greater, 4 wt-% or greater, or 5 wt-% or greater of poly(vinyl alcohol).

Embodiment 6 is the method of any one of embodiments 2 to 5, wherein the aqueous solution comprises 20 wt-% or less, 10 wt-% or less, 5 wt-% or less, 4 wt-% or less, 3 wt-% or less, or 2 wt-% or less of poly(vinyl alcohol).

Embodiment 7 is the method of any one of embodiments 2 to 6, wherein the poly(vinyl alcohol) in the aqueous solution has a hydrolyzation rate of 88% or greater, 90% or greater, 95% or greater, 98% or greater, or 99% or greater.

Embodiment 8 is the method of any one of embodiments 2 to 7, wherein the poly(vinyl alcohol) in the aqueous solution has a molecular weight of 50 kDa or greater, 75 kDa or greater, or 80 kDa or greater.

Embodiment 9 is the method of any one of embodiments 2 to 8, wherein the poly(vinyl alcohol) in the aqueous solution has a molecular weight of 120 kDa or less, 100 kDa or less, or 90 kDa or less.

Embodiment 10 is the method of any one of embodiments 2 to 9, wherein the poly(vinyl alcohol) in the aqueous solution is 99% or more hydrolyzed, has a molecular weight of 80 kDa to 90 kDa, and has a concentration of 1.5 wt-% to 2.5 wt-%.

Embodiment 11 is the method of any one of embodiments 2 to 10, wherein the method comprises placing the substrate in an aqueous bath containing 1-2 wt-% of fully (99%) hydrolyzed poly(vinyl alcohol) for at least 2 minutes.

Embodiment 12 is the method of embodiment 11, wherein the aqueous bath is at a temperature of about 20° C. to 26° C.

Embodiment 13 is the method of embodiment 11 or 12, further comprising rinsing the substrate, optionally rinsing the substrate with water.

Embodiment 14 is the method of any one of embodiments 11 to 13, further comprising contacting the substrate with a cross-linking composition containing a crosslinking agent suitable for crosslinking the coating composition.

Embodiment 15 is the method of embodiment 14, wherein the crosslinking composition comprises an aqueous solution of glutaraldehyde and H₂SO₄.

Embodiment 16 is the method of embodiment 14, wherein the substrate is immersed in an aqueous solution of 2 mM to 8 mM (optionally about 5 mM) glutaraldehyde and 0.1 M to 0.5 M (optionally about 0.25 M) H₂SO₄ at a temperature of 40° C. to 80° C. (optionally about 60° C.) for 1 minute to 5 minutes (optionally about 2 minutes).

Embodiment 17 is a porous article made by the method of any one of embodiments 2 to 17.

Embodiment 18 is a porous article comprising:
a porous substrate comprising ePTFE; and
a coating disposed on the porous substrate, the coating comprising an interpenetrating polymer network of PVOH and a second polymer, optionally wherein the second polymer comprises one or more of polyacrylic acid, poly (2-ethyl-2-oxazoline), poly(hydroxyethyl methacrylate), poly(hydroxyl propyl methacrylate), poly (4-vinylpyridine), poly(vinyl pyrrolidone), or polyethylene glycol.

Embodiment 19 is a porous article comprising:
a porous substrate comprising ePTFE; and
a coating disposed on the porous substrate, the coating comprising a first layer comprising poly(vinyl alcohol) and a second layer disposed on the first layer and comprising one or more of polyacrylic acid, poly (2-ethyl-2-oxazoline), poly(hydroxyethyl methacrylate), poly(hydroxyl propyl methacrylate), poly (4-vinylpyridine), poly(vinyl pyrrolidone), or polyethylene glycol.

Embodiment 20 is a porous article comprising:
a porous substrate comprising ePTFE; and
a first coating disposed on the porous substrate, the coating comprising poly(vinyl alcohol); and
a second coating disposed on the first coating, the second coating comprising a water-insoluble polymer.

Embodiment 21 is the porous article of embodiment 20, wherein the water-insoluble polymer comprises poly (2-hydroxylethylmethacrylate), poly(hydroxylpropyl methacrylate), or a combination thereof.

Embodiment 22 is the porous article of embodiment 21, wherein the water-insoluble polymer is formed by crosslinking a water-soluble polymer.

Embodiment 23 is the porous article of embodiment 22, wherein the water-soluble polymer comprises poly(lactic-co-glycolic acid), poly(ethyleneimine), or a combination thereof.

Embodiment 24 is a method of forming a porous article comprising:
a porous substrate comprising ePTFE; and
a coating disposed on the porous substrate, the coating comprising poly(vinyl alcohol), the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate; and
   applying a second coating composition to the film of poly(vinyl alcohol), the second coating compositions comprising a solution of poly(lactic-co-glycolic acid) in tetrahydrofuran.

Embodiment 25 is a method of forming a porous article comprising:
a porous substrate comprising ePTFE; and
a coating disposed on the porous substrate, the coating comprising poly(vinyl alcohol), the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate;
   applying a second coating composition to the film of poly(vinyl alcohol), the second coating compositions comprising poly(ethyleneimine) in methanol with a formaldehyde crosslinking agent; and evaporating the methanol at an elevated temperature to effect crosslinking of the poly(ethyleneimine).

Embodiment 26 is a method of forming a porous article comprising:
a porous substrate comprising ePTFE; and
a coating disposed on the porous substrate, the coating comprising poly(vinyl alcohol), the method comprising:
   applying a first coating composition to the porous substrate, the first coating composition comprising an aqueous solution comprising poly(vinyl alcohol);
   removing the aqueous solution and leaving a film of poly(vinyl alcohol) on the substrate;
   applying a second coating composition to the film of poly(vinyl alcohol), the second coating compositions comprising poly (2-hydroxyethylmethacrylate) in isopropanol; and evaporating the isopropanol.

Embodiment 27 is a porous article made by the method any one of embodiments 24 to 26.

Embodiment 28 is the porous article or method of any one of embodiments 18 to 27, wherein the first coating and the second coating form an interpenetrating polymer network (“IPN”).

Embodiment 29 is the porous article of any one of embodiments 18 to 28, wherein the poly(vinyl alcohol) has a molecular weight of 80 kDa or greater, 90 kDa or greater, or 100 kDa or greater.

Embodiment 30 is the porous article of any one of embodiments 18 to 29, wherein the poly(vinyl alcohol) in the aqueous solution has a molecular weight of 300 kDa or less, 200 kDa or less, or 150 kDa or less.

Embodiment 31 is a porous article comprising:
a porous substrate comprising ePTFE; and
a coating disposed on the porous substrate, the coating comprising a first poly(vinyl alcohol) and one or more surfactants.

Embodiment 32 is the porous article of embodiment 31, wherein the one or more surfactants comprises an anionic surfactant or non-ionic surfactant.

Embodiment 33 is the porous article of embodiment 31, wherein the one or more surfactants comprises sodium dodecyl sulfate, sorbitan monooleate, polyethylene glycol sorbitan monolaurate, or polyoxyethylene-polyoxypropylene block co-polymer, or a combination of two or more thereof.

Embodiment 34 is the porous article of any one of embodiments 31 to 33, wherein the coating is formed from a coating composition comprising the surfactant at a concentration of 0.5 wt-% or greater, 1 wt-% or greater, 1.5 wt-% or greater, or 2 wt-% or greater.

Embodiment 35 is the porous article of any one of embodiments 31 to 34, wherein the coating is formed from a coating composition comprising the surfactant at a concentration of 5 wt-% or less, 4 wt-% or less, 3 wt-% or less, or 2 wt-% or less.

Embodiment 36 is the porous article of any one of embodiments 31 to 35, wherein the first poly(vinyl alcohol) has a first molecular weight and first degree of hydrolysis, the coating further comprising a second poly(vinyl alcohol) having a second molecular weight and second degree of hydrolysis.

Embodiment 37 is a method of forming a porous article comprising:
a porous substrate comprising ePTFE; and
a coating disposed on the porous substrate, the coating comprising a first poly(vinyl alcohol) and one or more surfactants,
the method comprising:
   applying a first coating composition in a first coating step to the porous substrate, the first coating composition comprising an aqueous solution comprising poly(vinyl alcohol), and the first coating step being performed using a first set of coating parameters comprising temperature, molecular weight distribution of the poly(vinyl alcohol), degree of hydrolysis of the poly(vinyl alcohol), optional presence of an additive, and optional presence and composition of a surfactant; and
   applying a second coating composition in a second coating step to the first coating composition, the second coating composition comprising an aqueous solution comprising poly(vinyl alcohol), and the second coating step being performed using a second set of coating parameters comprising temperature, molecular weight distribution of the poly(vinyl alcohol), degree of hydrolysis of the poly(vinyl alcohol), optional presence of an additive, and optional presence and composition of a surfactant, wherein at least one of the coating parameters is different from the first set of coating parameters, and wherein at least one of the first and second coating compositions comprises a surfactant; and
   drying the coating.

Embodiment 38 is the method of embodiment 37 comprising removing water from the aqueous solution after the first coating step and before the second coating step.

Embodiment 39 is the method of embodiment 37 or 38, wherein the surfactant comprises an anionic surfactant or non-ionic surfactant.

Embodiment 40 is the method of any one of embodiments 37 to 39, wherein the surfactant comprises sodium dodecyl sulfate, sorbitan monooleate, polyethylene glycol sorbitan monolaurate, or polyoxyethylene-polyoxypropylene block co-polymer, or a combination of two or more thereof.

Embodiment 41 is the method of any one of embodiments 37 to 40, wherein the first coating composition, the second coating composition, or both comprise the surfactant at a concentration of 0.5 wt-% or greater, 1 wt-% or greater, 1.5 wt-% or greater, or 2 wt-% or greater.

Embodiment 42 is the method of any one of embodiments 37 to 41, wherein the first coating composition, the second coating composition, or both comprise the surfactant at a concentration of 5 wt-% or less, 4 wt-% or less, 3 wt-% or less, or 2 wt-% or less.

Embodiment 43 is the method of any one of embodiments 37 to 42, wherein the first coating composition comprises a first poly(vinyl alcohol) with a first molecular weight and the second coating composition comprises a second poly(vinyl alcohol) with a second molecular weight different from the first molecular weight.

Embodiment 44 is the method of any one of embodiments 37 to 43, wherein the first coating composition comprises a first poly(vinyl alcohol) with a first degree of hydrolysis, and the second coating composition comprises a second poly(vinyl alcohol) with a second degree of hydrolysis different from the first degree of hydrolysis.

Embodiment 45 is a porous article comprising:
a porous substrate comprising ePTFE; and
a coating disposed on the porous substrate, the coating comprising a first poly(vinyl alcohol) having a first molecular weight and first degree of hydrolysis, and a second poly(vinyl alcohol) having a second molecular weight and second degree of hydrolysis.

Embodiment 46 is a porous article comprising:
a porous substrate comprising ePTFE; and
a coating disposed on the porous substrate, the coating comprising poly(vinyl alcohol) and a biological molecule covalently attached to the poly(vinyl alcohol).

Embodiment 47 is the porous article of embodiment 46, wherein the biological molecule comprises an amino acid, a polypeptide, a saccharide, or a polysaccharide.

Embodiment 48 is the porous article of embodiment 46 or 47, wherein the biological molecule comprises a first reactive handle, and the poly(vinyl alcohol) comprises a second reactive handle, and wherein the first reactive handle and the second reactive handle are cooperative and react in a bioconjugation reaction.

Embodiment 49 is a method of forming a porous article comprising:
a porous substrate comprising ePTFE; and
a coating disposed on the porous substrate, the coating comprising poly(vinyl alcohol) and a biological molecule covalently attached to the poly(vinyl alcohol),
the method comprising:
   applying a coating composition onto the porous substrate, the coating composition comprising poly(vinyl alcohol) and the biological molecule; and
   covalently coupling the biological molecule to the poly(vinyl alcohol).

Embodiment 50 is the method of embodiment 49, wherein the biological molecule and the poly(vinyl alcohol) react in a bioconjugation reaction.

Embodiment 51 is a porous article comprising:
a porous substrate comprising ePTFE; and
a coating disposed on the porous substrate, the coating comprising poly(vinyl alcohol) and a second polymer grafted onto the poly(vinyl alcohol).

Embodiment 52 is the porous article of embodiment 51, wherein the second polymer comprises polyethylene glycol (PEG), linear polyethylene imine (PEI), polyallyl alcohol (PAIA), polyacrylic acid (PAA), polyacrylic acid sodium salt (PAANa), poly (2-hydroxyethyl methacrylate) (PHEMA), or any combination thereof.

Embodiment 53 is a method of forming a porous article comprising:
a porous substrate comprising ePTFE; and
a coating disposed on the porous substrate, the coating comprising poly(vinyl alcohol) and a second polymer grafted to the poly(vinyl alcohol),
the method comprising:
   applying a coating composition onto the porous substrate, the coating composition comprising the poly(vinyl alcohol) and the second polymer; and
   covalently coupling the second polymer to the poly(vinyl alcohol) to form the porous article.

Embodiment 54 is the method of embodiment 53, wherein the covalently coupling the second polymer to the poly(vinyl alcohol) comprises reacting a coupling agent with the poly(vinyl alcohol) and the second polymer.

Embodiment 55 is the method of embodiment 53 or 54, wherein the coupling agent comprises glutaraldehyde, carbodiimide (optionally dicyclohexylcarbodiimide), carbonyldiimidazole, disuccinimidyl carbonate, epichlorohydrin, or a combination of two or more thereof.

Embodiment 56 is the method of any one of embodiments 53 to 55, wherein the second polymer comprises polyethylene glycol (PEG), linear polyethylene imine (PEI), polyallyl alcohol (PAIA), polyacrylic acid (PAA), polyacrylic acid sodium salt (PAANa), Poly(2-hydroxyethyl methacrylate) (PHEMA), or a combination of two or more thereof.

Embodiment 57 is the method of embodiment 53, wherein the poly(vinyl alcohol) comprises a modified poly(vinyl alcohol) comprising a functional group, the method further comprising reacting the functional group with a modified hydrophilic polymer comprising a maleimide, iodoacetamide, alkyne, azide, thiol-ene, thiol-yne, isocyanate, or a combination thereof.

Embodiment 58 is a method of forming a porous article comprising:
a porous substrate comprising ePTFE; and
a coating disposed on the porous substrate, the coating comprising a copolymer of poly(vinyl alcohol) and a second polymer grafted from the poly(vinyl alcohol),
the method comprising:
   grafting the second polymer from the poly(vinyl alcohol) to form the copolymer; and
   applying a coating composition onto the porous substrate, the coating composition comprising the copolymer.

Embodiment 59 is a method of forming a porous article comprising:
a porous substrate comprising ePTFE; and
a coating disposed on the porous substrate, the coating comprising a copolymer of poly(vinyl alcohol) and a second polymer grafted from the poly(vinyl alcohol),
the method comprising:
   applying a coating composition onto the porous substrate, the coating composition comprising the poly(vinyl alcohol), one or more monomers, and an initiator; and
   polymerizing the one or more monomers from the poly(vinyl alcohol) to form the copolymer.

Embodiment 60 is the method of embodiment 58 or 59, wherein the grafting-from polymerization is performed using ring opening polymerization, an atom transfer radical polymerization (ATRP) initiator or a reversible addition-fragmentation chain-transfer polymerization (RAFT) initiator.

Embodiment 61 is the method of any one of embodiments 58 to 60, wherein the second polymer comprises a hydrophilic polymer comprising 100 or fewer repeating units.

Embodiment 62 is the method of any one of embodiments 58 to 61, wherein the second polymer comprises polyethylene glycol (PEG), polyglycidyl ether, polylactide, polycarbonate, polyacrylic acid (PAA), polyacrylic acid sodium salt (PAANa), Poly (2-hydroxyethyl methacrylate) (PHEMA), or a combination of two or more thereof.

Embodiment 63 is the method of any one of embodiments 53 to 62, wherein the second polymer comprises 4 or more, 6 or more, 10 or more, 15 or more, or 20 or more repeating units.

Embodiment 64 is the method of any one of embodiments 53 to 63, wherein the second polymer comprises 100 or fewer, 80 or fewer, 60 or fewer, 40 or fewer, or 20 or fewer repeating units.

Embodiment 65 is a porous article made by the method of any one of embodiments 53 to 64.

Embodiment 66 is a method of forming a porous article comprising:
a porous substrate comprising ePTFE; and
a coating disposed on the porous substrate, the coating comprising crosslinked poly(vinyl alcohol),
the method comprising:
   exposing the poly(vinyl alcohol) to a crosslinking solution to crosslink the poly(vinyl alcohol), the crosslinking solution comprising a crosslinking agent and a photoacid catalyst; and
   illuminating the poly(vinyl alcohol) with ultraviolet light.

Embodiment 67 is the method of embodiment 66, wherein the crosslinking agent comprises dialdehyde, optionally wherein the dialdehyde comprises glutaraldehyde, terephthalaldehyde, phthalaldehyde, glyoxal, or a combination of two or more thereof.

Embodiment 68 is a porous article made by the method of embodiment 66 or 67.

Embodiment 69 is a porous article comprising:
a porous substrate comprising ePTFE; and
a coating disposed on the porous substrate, the coating comprising poly(vinyl alcohol) comprising crosslinked allyl groups, propargyl groups, diazirine groups, acrylate functional groups, or a combination of two or more thereof.

Embodiment 70 is a method of preparing a porous article comprising:
a porous substrate comprising ePTFE; and
a coating disposed on the porous substrate, the coating comprising poly(vinyl alcohol) comprising crosslinked allyl groups, propargyl groups, diazirine groups, acrylate functional groups, or a combination of two or more thereof,
the method comprising:
   applying a coating composition comprising poly(vinyl alcohol) onto the porous substrate;
   contacting the poly(vinyl alcohol) with a solution comprising one or more of allyl groups, propargyl groups, diazirine groups, and acrylate functional groups; and
   crosslinking the one or more of allyl groups, propargyl groups, diazirine groups, and acrylate functional groups.

Embodiment 71 is a method of preparing a porous article comprising:
a porous substrate comprising ePTFE; and
a coating disposed on the porous substrate, the coating comprising poly(vinyl alcohol) comprising crosslinked allyl groups, propargyl groups, diazirine groups, acrylate functional groups, or a combination of two or more thereof,
the method comprising:
   preparing a modified poly(vinyl acetate) by polymerizing a solution of vinyl acetate and a monomer comprising a crosslinkable functional handle;
   hydrolyzing the modified poly(vinyl acetate) to prepare a modified poly(vinyl alcohol);
   applying a coating composition comprising the modified poly(vinyl alcohol) onto the porous substrate; and
   crosslinking the crosslinkable functional handle.

Embodiment 72 is a porous article comprising:
a porous substrate comprising ePTFE; and
a coating disposed on the porous substrate, the coating comprising poly(vinyl alcohol) crosslinked with a crosslinking agent comprising more than two reactive groups per crosslinking agent.

Embodiment 73 is a method of preparing the porous article of embodiment 40, the method comprising:
applying a coating composition comprising poly(vinyl alcohol) onto the porous substrate; and
crosslinking the poly(vinyl alcohol) using a crosslinking agent comprising more than two reactive groups per crosslinking agent.

Embodiment 74 is the method of embodiment 73, wherein the poly(vinyl alcohol) is first modified to include cross-linkable functional groups (optionally comprising allyl, propargyl, or acrylate functional groups) to form a modified poly(vinyl alcohol), and the modified poly(vinyl alcohol) is crosslinked.

Embodiment 75 is the method of embodiment 73 or 74, wherein the crosslinking is performed via photoinitiated chemistry or thermal annealing.

Embodiment 76 is the porous article or method of embodiment 72 or 73, wherein the crosslinking agent comprises trifunctional aldehyde such as 2,4,6-trihydroxybenzene-1,3,5-tricarbaldehyde; a triglycidyl ether such as trimethylolethane triglycidyl ether or trimethylolpropane triglycidyl ether; or a small molecule or oligomer comprising more than two reactive functional groups selected from aldehydes, cyclic ethers, cyclic esters, and alkyl halides.

Embodiment 77 is the porous article or method of any one of the preceding embodiments, wherein the porous substrate is a fibrous article.

Embodiment 78 is the porous article or method of any one of the preceding embodiments, wherein the porous substrate is a thin film or membrane.

Embodiment 79 is the porous article or method of any one of the preceding embodiments, wherein the coating is a conformal coating.

Embodiment 80 is the porous article or method of any one of the preceding embodiments, wherein the porous substrate has an average pore size in a range of 1 nm to 1 mm, 1 nm to 1 μm, 1 nm to 0.5 μm, 0.1 μm to 0.6 μm, 1 μm to 1 mm, or 100 μm to 1 mm. The pore size may be measured according to ASTM D6767-21.

Embodiment 81 is the porous article or method of any one of the preceding embodiments, wherein the coated porous substrate has an average pore size of 1 mm or less, 100 μm or less, 10 μm or less, 1 μm or less, 0.6 μm or less, 0.5 μm or less, 0.4 μm or less, 0.3 μm or less, 0.2 μm or less, 0.1 μm or less, or 0.01 μm or less. The pore size may be measured according to ASTM D6767-21.

Embodiment 82 is the porous article or method of any one of the preceding embodiments, wherein the coated porous substrate has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability may be Frazier permeability measured according to ASTM D737-18.

Embodiment 83 is the porous article or method of any one of the preceding embodiments, wherein the coated porous substrate has a permeability of 2 cm³/s/cm² or less, 1.5 cm³/s/cm² or less, 1.0 cm³/s/cm² or less, or 0.8 cm³/s/cm² or less. The permeability may be Frazier permeability measured according to ASTM D737-18.

Embodiment 84 is the porous article or method of any one of the preceding embodiments, wherein the coated porous article has a permeability of 0.02 cm³/s/cm² or greater, 0.05 cm³/s/cm² or greater, 0.1 cm³/s/cm² or greater, 0.2 cm³/s/cm² or greater, 0.3 cm³/s/cm² or greater, or 0.5 cm³/s/cm² or greater. The permeability may be Frazier permeability measured according to ASTM D737-18.

Embodiment 85 is the porous article or method of any one of the preceding embodiments, wherein the coated porous article has a permeability of 2 cm³/s/cm² or less, 1.5 cm³/s/cm² or less, 1.0 cm³/s/cm² or less, or 0.8 cm³/s/cm² or less. The permeability may be Frazier permeability measured according to ASTM D737-18.

Embodiment 86 is the porous article or method of any one of the preceding embodiments, wherein the porous substrate has a thickness of 0.1 μm or greater, 0.5 μm or greater, 1 μm or greater, 5 μm or greater, 10 μm or greater, or 100 μm or greater.

Embodiment 87 is the porous article or method of any one of the preceding embodiments, wherein the porous substrate has a thickness of 5 mm or less, 2 mm or less, 1 mm or less, 500 μm or less, 200 μm or less, 100 μm or less, 50 μm or less, 25 μm or less, 10 μm or less, 5 μm or less, 2 μm or less, or 1 μm or less.

Embodiment 88 is the porous article or method of any one of the preceding embodiments, wherein the coating has a thickness of 250 nm or less, 200 nm or less, 150 nm or less, 100 nm or less, 50 nm or less, 20 nm or less, 10 nm or less, or 5 nm or less.

Embodiment 89 is the porous article or method of any one of the preceding embodiments, wherein the coating has a thickness of 0.5 nm or greater.

Embodiment 89 is a filter comprising a housing with an interior, an inlet, and an outlet, and filter media disposed within the interior of the housing and comprising the porous article of any of the preceding embodiments.

### Example

A porous ePTFE membrane was treated to have a hydrophilic coating. The ePTFE membrane had a thickness of about 150-200 μm and pore size of 1-5 μm. The ePTFE membrane was submerged in a bath of isopropyl alcohol for 10 minutes. While the ePTFE membrane was still wetted by the isopropyl alcohol, it was then submerged into a bath of DI water for an additional 10 minutes. Finally, the membrane was moved to a bath containing a 2 wt-% solution of polyvinyl alcohol in water for 10 minutes. The membrane was then dried in an oven at 150° C. for 10 minutes. The membrane was confirmed to be completely wetting to water after drying with a pore size remaining at 1-5 microns and a final thickness of 90-150 microns.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

What is claimed is:

1. A porous article comprising:
a porous substrate comprising ePTFE; and
a coating disposed on the porous substrate, the coating comprising poly(vinyl alcohol) and a biological molecule covalently attached to the poly(vinyl alcohol), optionally wherein the biological molecule comprises an amino acid, a polypeptide, a saccharide, a polysaccharide.

2. A method of forming the article of claim 1, the method comprising:
covalently coupling the biological molecule to the poly(vinyl alcohol) to form the porous article, optionally wherein the biological molecule and the poly(vinyl alcohol) react in a bioconjugation reaction.

3. A porous article comprising:
a porous substrate comprising ePTFE; and
a coating disposed on the porous substrate, the coating comprising poly(vinyl alcohol) and a second polymer grafted on the poly(vinyl alcohol), optionally wherein the second polymer comprises polyethylene glycol (PEG), linear polyethylene imine (PEI), polyallyl alcohol (PAIA), polyacrylic acid (PAA), polyacrylic acid sodium salt (PAANa), poly (2-hydroxyethyl methacrylate) (PHEMA), or any combination thereof.

4. A method of forming the article of claim 3, the method comprising:
covalently coupling the second polymer to poly(vinyl alcohol) to form the porous article, optionally wherein the covalently coupling the second polymer comprises reacting a coupling agent with the poly(vinyl alcohol) and the second polymer.

5. A method of forming a porous article comprising:
a porous substrate comprising ePTFE; and
a coating disposed on the porous substrate, the coating comprising crosslinked poly(vinyl alcohol),
the method comprising:
exposing the poly(vinyl alcohol) to a crosslinking solution to crosslink the poly(vinyl alcohol), the crosslinking solution comprising a crosslinking agent and a photoacid catalyst; and
illuminating the poly(vinyl alcohol) with ultraviolet light.

6. A porous article comprising:
a porous substrate comprising ePTFE; and
a coating disposed on the porous substrate, the coating comprising poly(vinyl alcohol) comprising crosslinked allyl groups, propargyl groups, diazirine groups, acrylate functional groups, or a combination of two or more thereof.

7. A method of preparing the porous article of claim 6, the method comprising:
applying a coating composition comprising poly(vinyl alcohol) onto the porous substrate;
contacting the poly(vinyl alcohol) with a solution comprising one or more of allyl groups, propargyl groups, diazirine groups, and acrylate functional groups; and
crosslinking the one or more of allyl groups, propargyl groups, diazirine groups, and acrylate functional groups.

8. A method of preparing the porous article of claim 6, the method comprising:
preparing a modified poly(vinyl acetate) by polymerizing a solution of vinyl acetate and a monomer comprising a crosslinkable functional handle;
hydrolyzing the modified poly(vinyl acetate) to prepare a modified poly(vinyl alcohol);
applying a coating composition comprising the modified poly(vinyl alcohol) onto the porous substrate; and
crosslinking the crosslinkable functional handle.

9. A porous article comprising:
a porous substrate comprising ePTFE; and
a coating disposed on the porous substrate, the coating comprising poly(vinyl alcohol) crosslinked with a crosslinking agent comprising more than two reactive groups per crosslinking agent.

10. A method of preparing the porous article of claim 9, the method comprising:
applying a coating composition comprising poly(vinyl alcohol) onto the porous substrate; and
crosslinking the poly(vinyl alcohol) using a crosslinking agent comprising more than two reactive groups per crosslinking agent.
